(19) United States
(12) Patent Application Publication
(10) Pub. No.: US 2013/0013474 A1
(43) Pub. Date: Jan. 10, 2013

(54) System and method for modifying an index-based hierarchal cost model of a complex system

(76) Inventors: Charles Christopher Whelan, Essex, CT (US); Lu Jin, Wellesley, MA (US); Joseph C. Levesque, Westborough, MA (US); Richard Paul Schuster, Salem, MA (US); Xiangjun Mai, Quincy, MA (US)

(21) Appl. No.: 13/135,408

(22) Filed: Jul. 5, 2011

(51) Int. Cl. G06Q 40/00

(52) U.S. Cl. 705/35

(57) ABSTRACT

A method is provided of modifying a hierarchal cost model of a multi-component system over a time period of the model extending from a historical time to a future time, wherein the model is built from item cost indices, each of which is built from one or more commodity price indices created from market data. The model is stored in memory of a computer system that includes a processor, a user input device and a display. The method includes the steps of selecting an item from the model, selecting a time from the model time period (the selected item time), and inputting a user selected cost of the item for the selected time. The processor modifies the item price index to create a custom item price index based on the input item price, the selected item date, and the item's constituent cost indices, and stores the custom price index in the memory. The method may further include modifying the cost model to create a custom cost model based on the custom item price index, and storing the custom cost model in memory. The custom item price index and all aspects of the custom model can then be used and displayed as before.

### BACKGROUND OF THE INVENTION

The invention relates to systems and methods for creating and modifying cost models of complex systems.

Large enterprises can incur substantial costs to construct new facilities and in the operation and maintenance of those facilities. In some industries, such as energy development, generation, and transmission, the costs for a single project can run into the hundreds or even billions of dollars. The cost for a large project will typically involve different cost categories, including capital equipment, engineering, labor, and specialty services. The costs for each category can be further broken down into subcategory, item, and component costs.

As an example, construction of a new thermal electric power generating facility will have capital costs associated with site development, building construction, generating equipment, safety systems, control systems, and transmission systems. Generating equipment can include items such as fueling systems, boilers, turbines, cooling systems, and plumbing. Breaking the costs down even further, the cost of a turbine delivered to the site of a new plant will have built into it the costs of its components, which can include items such as bearings, copper wire, magnets, housing, and electronics, as well as the costs of assembly, transportation and design engineering if it is made to custom specifications. The cost of copper wire can also be broken down into key component costs, such as copper, insulation, and fabrication.

It typically falls to the enterprise's internal supply chain services to contract for facilities construction projects and for the operation and maintenance (O&M) of facilities. The supply chain specialists will work with internal engineering on the specifications for the subsystems and components, estimate the costs, including for engineering and labor, and send out requests for proposals (RFPs) or requests for quotations (RFQs) to suppliers. After evaluating the submitted proposals and quotes, vendors are selected and contracts entered into, sometimes with further negotiation between the parties.

In theory, this process will provide the enterprise carrying out the project or O&M activity with fair market price. However, there is no way it can evaluate whether this is actually true. The original estimate is typically based on the experience of its employees with other projects or O&M activities, and advice from suppliers and consultants. The historical data available will typically include a limited number of transactions, which may or may not be applicable to the current project, and may have built-in biases to certain suppliers. Data coming from suppliers may be self-serving. Consultants work under similar limitations, and additional cost data they provide will most likely come from public data, not actual transaction pricing. Cost estimates based on the enterprise's historical data typically will not capture market trends that could affect future pricing when the project or O&M activities are actually carried out. Planning and estimating costs is even more difficult when the enterprise has little or no historical experience with a type of project or O&M activity.

It would be beneficial for planning and sourcing of O&M activities and construction projects to have a broader database of transactions to rely on, as well as more predictive information about commodity, labor and other price drivers. In recent years new tools have been introduced to give executives, project developers, and supply chain leaders better visibility and predictability into O&M and project construction costs. One such tool, offered for license by Power Advocate, Inc. (PowerAdvocate®) of Boston, Mass. under the product name Cost Intelligence®, is an internet accessible software application that provides access to hierarchal cost models for various types of facility O&M activities and construction projects for the energy industry. The cost models are built from a database of thousands of cost indices, each representing the cost of a commodity over an historical time period and projected for a future period of time. As used herein, a commodity could be a material (e.g. copper), a service (e.g. pipefitter construction unionized labor), or a commoditized value-added item or service (e.g. PVC tubing). Higher level objects of the cost model are built up from the cost indices of their constituent elements. For example, the cost index for an object in the next higher tier of the model hierarchy, called an item, will comprise the cost indices of its constituent commodities. Similarly, the cost index of a sub-category will comprise the cost indices of its constituent items; a category cost index will comprise the cost indices of its constituent sub-categories; and the cost model, at the highest level, will include the cost indices for all its constituent categories. The data in the commodity indices are price values associated with succeeding time periods, i.e. quarter-year price points, and is updated for subscribers quarterly.

The commodity cost indices are built from respected third-party and government databases, and independent research and analysis of regional, national, and global events, transactions, and trends that impact supply and demand. An aggregate cost index for an item requires an allocation between its constituent commodity indices. This allocation is based on extensive market research and expert analysis, and is designed to reflect how the item's price has changed over time. Moreover, the cost index for each object at the item level is normalized to actual price points from a large historical database of transactions from across the energy industry. A normalized item cost index, to the extent the market price varies from its direct input costs (i.e. its constituent commodity indices) therefore includes an intangibles factor that accounts for the difference. This difference over time may be driven by market forces, e.g. demand dynamics, supply and shipping constraints, manufacturer economies of scale, production and market efficiencies, regulation changes, political and force majeure events, profit margin, and warranty costs. The intangibles factor for an item is also stored with the commodity cost indices for that item.

The Cost Intelligence software is configured so that users can view a cost model at any desired level of granularity, from the commodity indices on up, to isolate and examine costs on a variety of different levels and by a number of different variables. Information can be displayed graphically, e.g., with charts of the indices' price variations over time, and pie or bar charts of indices' component costs or component percentages at a selected time. Information can also be displayed in list or spreadsheet form. Each tier of analysis provides a different view of the costs associated with a facility or program's O&M or construction costs, depending on the model. Users can also customize the models, for example, by removing items and categories that are not relevant to their particular needs, or substituting a regional commodity cost index for a global index. The software includes a should-cost calculator configured to allow a user to calculate what the cost for an item (or other object in the model) would project to be at a selected time if it was known to be a certain price at a different time. For example, if a user inputs that his business paid $50,000 for a distribution transformer in Q2 of 2006 and selects the most recent quarter-year time period of the model (i.e., the most current update period), the calculator will use the index for that item to provide a projected price for the selected quarter. However, the should-cost calculation does not change the data in the underlying model. Users can also build their own models using the PowerAdvocate commodity indices and item indices.

These capabilities provide executives, project developers, and supply chain leaders with visibility and predictability into facility operations and maintenance programs and facility construction costs. Decision makers can isolate detailed factors and major drivers that impact component and facility costs. The improved cost knowledge enables businesses to have better decision-making confidence and accuracy, negotiate better contracts with suppliers, improve budgeting and increase understanding of budget variances. A business can benchmark its performance against the market, identify cost saving opportunities, and identify and mitigate the risks of commodity volatility.

### SUMMARY OF THE INVENTION

In one aspect, the invention provides a computer-mediated method of modifying a hierarchal cost model of a multi-component system over a time period of the model extending from a first (or historical) date to a second (or future) date. The model is built from a plurality of item cost indices, each of which is built from one or more commodity price indices created from market data. The model is stored in memory of a computer system that includes a processor, a user input device and a display. The method includes the steps of selecting an item from the model, selecting a time from the model time period (the selected item time), and inputting a user selected cost of the item for the selected time (the custom item price). The processor modifies the item price index to create a custom item price index based on the custom item price, the selected item date, and the item's constituent cost indices, and stores the custom price index in the memory. The method may further include modifying the cost model to create a custom cost model based on the custom item price index, and storing the custom cost model in memory. The custom item price index and all aspects of the custom model can then be used and displayed as before.

In one embodiment, the selected item time is an historical time. In another embodiment, the selected item time is a future time. In a preferred embodiment, the custom item price is a transaction price, which may be from an historical transaction, or from a future contract. The custom item price may also be any other price selected by the user.

### BRIEF DESCRIPTION OF THE DRAWING

FIG. 1 is a schematic representation of a distributed computer system for carrying out the invention.

FIG. 2 is a screen shot display of the computer program product of the invention showing a user's model dashboard.

FIG. 3 is a screen shot display of a users licensed models.

FIG. 4 is a screen shot display of a selected model showing different model viewing tools.

FIG. 5 is an expanded view of the model's Index & Forecast tool.

FIG. 6 is an expanded view of the model's Data tool table.

FIG. 7 is an expanded view of the model's Cost Breakdown tool.

FIGS. 8-10 are screen shot views of the model showing an expanded Model Navigation panel, with different categories and subcategories shown expanded and displayed.

FIG. 11 is a view of an item's constituent commodities using the Cost Breakdown Tool list view.

FIG. 12 is an expanded view of the model's Commodity Index & Forecast tool for a selected item.

FIGS. 13-5 are screen shots of the model's item, category and subcategory configuration views.

FIG. 16 is an item configuration view of the model with a selected item expanded to show its constituent commodities and their respective percentage contribution to the item's cost for the present term.

FIG. 17-19 are views similar to that of FIG. 16, with the Time Machine application opened and its slide bar displayed. In FIG. 17 the slide bar is set at the present term; in FIG. 18 it is set at an historic term; and in FIG. 19 it is set at a future term.

FIG. 20 is a view similar to FIG. 18, with a user defined cost for the selected item.

FIG. 21 shows a pop-up display for entering information related to saving a model.

FIGS. 22-23 are views similar to FIGS. 16 and 19 for a newly saved model, illustrating how the selected item cost values have been changed in the recalculated model.

FIGS. 24-25 are a screen shot views of the original and modified models with the Model Navigation panel expanded to illustrate how category and subcategory percentage contributions are changed.

FIG. 26 is a view similar to that of FIG. 16, with different commodity percentage contributions entered bu a user for a selected historic term.

FIGS. 27-28 are views similar to that of FIG. 26, showing modified the item cost value and commodity index percentage contribution values being changed in a second modified model.

FIG. 29 is flow diagram illustrating steps of a method according to the invention of recalculating cost values of overlaying indices when an item cost value is changed.

FIG. 30 is a flow diagram illustrating a method according to another aspect of the invention for recalculating index values for all times throughout a model.

### DETAILED DESCRIPTION

The invention provides new and valuable functional enhancements to a cost modeling tool for complex systems that enable users to easily customize a system cost model with data from actual transactions. An exemplary embodiment will be described with reference to the PowerAdvocate® Cost Intelligence® web-accessible software service product, which provides subscribers access to a library of standard cost models for facility construction projects and facility O&M activities for the energy industry. Each model is a hierarchal object in which the construction project or O&M activity is deconstructed into logical groupings of categories, sub-categories, and items. A model may include hundreds of items. The item level is typically the level at which a distinct material, assembly, or service is purchased for carrying out the project or activity. An item can represent a relatively simple and straightforward thing or service, such as structural steel or labor for coatings, or it could represent a more complex manufactured system or assembly, such as a steam turbine for generating electricity, or skilled custom services, such as engineering. The items, in turn, are each comprised of one or more commodity price indices.

Thousands of commodity price indices may be used in a single cost model, and each item in the model has its own set of commodity cost indices associated with it. The commodity cost indices are built from respected third-party and government databases, and independent research and analysis of regional, national, and global events, transactions, and trends that impact supply and demand. In the described embodiment, each commodity index for an item provides a index price value for that commodity for each quarter-year period over an historical time period ranging from the first quarter of the year 2000 (1Q2000) to a recent quarter year term (designated the ‘present term’). The indices are also projected for a five-year future time period after the present term. The commodity price indices are updated each quarter, and the present term, which is the time period most recently updated, includes the most current historical data. The projected future commodity price indices are based on expert analysis of information from a variety of sources, including market and technology trends, government, industry and private service forecasts, and independent research.

The index for each sub-category is based on a percentage allocation for each of its constituent items, the index for each category is based on a percentage allocation of each of its sub-categories, and an index for the entire model is based on a percentage allocation for each of its categories. In the exemplary embodiment, an initial normalized index value for each commodity (and for each item, sub-category, and category, and for the entire model) is set at a value of 100 for the first quarter of the year 2000 (2000Q1).

Even though the models are built using supply market commodities and transaction data, all costs and indices are general estimates and reflect industry averages or approximations and do not represent any single or specific supplier's cost or pricing information, or any one supplier's position within the market. The indices represent overnight capital costs associated with the procurement of services, materials and equipment, so no escalation is assumed. Costs that are specific to a particular project, such as land acquisition, and soft costs, such as the cost of capital, performance premiums and contingencies, are not included in the models.

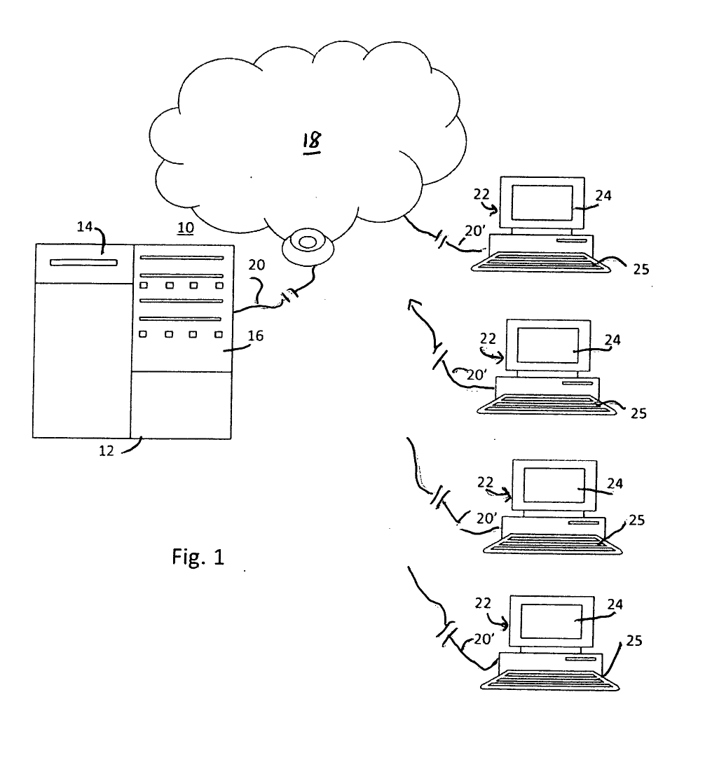

Reference will now be made to the Drawing to illustrate the features of the invention in the described embodiment. Referring now to the FIG. 1, a host computer system 10 includes a server 12 that has a memory 14 that stores cost models and software code for using the models, and a processor 16 for carrying out instructions provided by the software that enable subscribers to access cost models, modify the models, and create new cost models. The server 12 is communicatively coupled to the internet 18 with I/O 20. Subscribers have respective general purpose computer systems 22 that are communicatively connected to the internet 18 with respective I/O's 20′. Each subscriber system 22 includes a display 24 and a user input 25, which may include one or more of a keyboard, a mouse, a touch screen, etc. A subscriber system 22 may optionally include peripheral devices (not illustrated), such as printers and storage devices. In alternative embodiments, the host and subscriber systems may be connected via a private network, or may be combined in a single computer system.

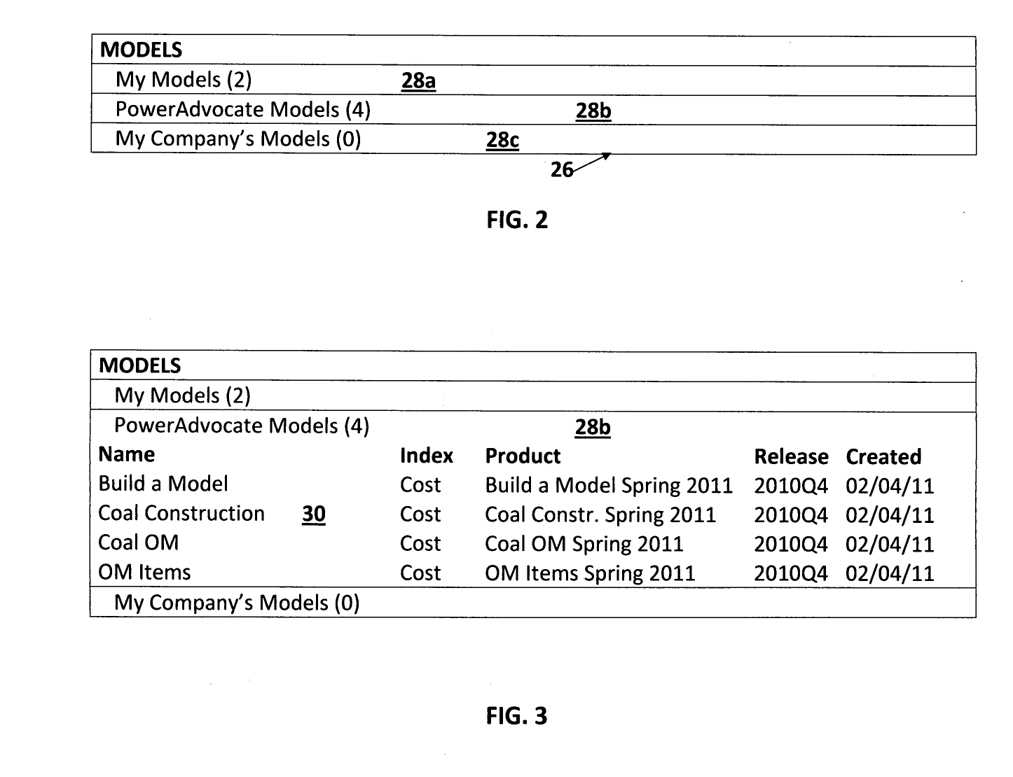

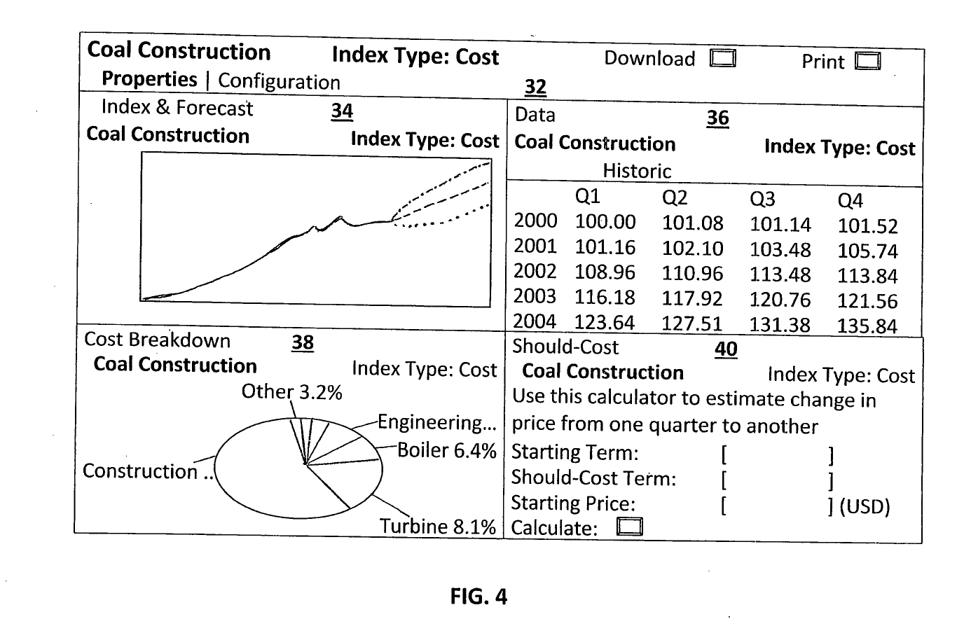

A subscriber (or ‘user’) of the software and models uses their subscriber system 22 to log into the host system 10 to access the models and the software. Referring now to FIG. 2, after logging in the user's display 24 will show a dashboard 26 that includes panels 28a, 28b, 28c that can be selected to respectively access the user's saved models, subscription models, and other models saved by colleagues within the user's company. Selecting panel 28b, for example, expands the panel to display a listing of the subscription models 30 as shown in FIG. 3. One of the models, entitled Coal Construction, is for construction of a pulverized coal electric generating facility in the United States with two steam generators and the latest in environmental technology. Other assumptions built into the model include site condition, access to rail lines and electric transmission lines, types of transformers, electrical interconnects, and geographic location. Selecting the exemplary Coal Construction model will display the model in a new dashboard 32 as shown in FIG. 4. Dashboard 32 presents aspects of the model in five expandable panels: Index and Forecast panel 34, Data panel 36, Cost Breakdown panel 38, Should-Cost panel 40, and a Commentary panel, which is hidden in FIG. 4 but which a user can view by scrolling down the display screen.

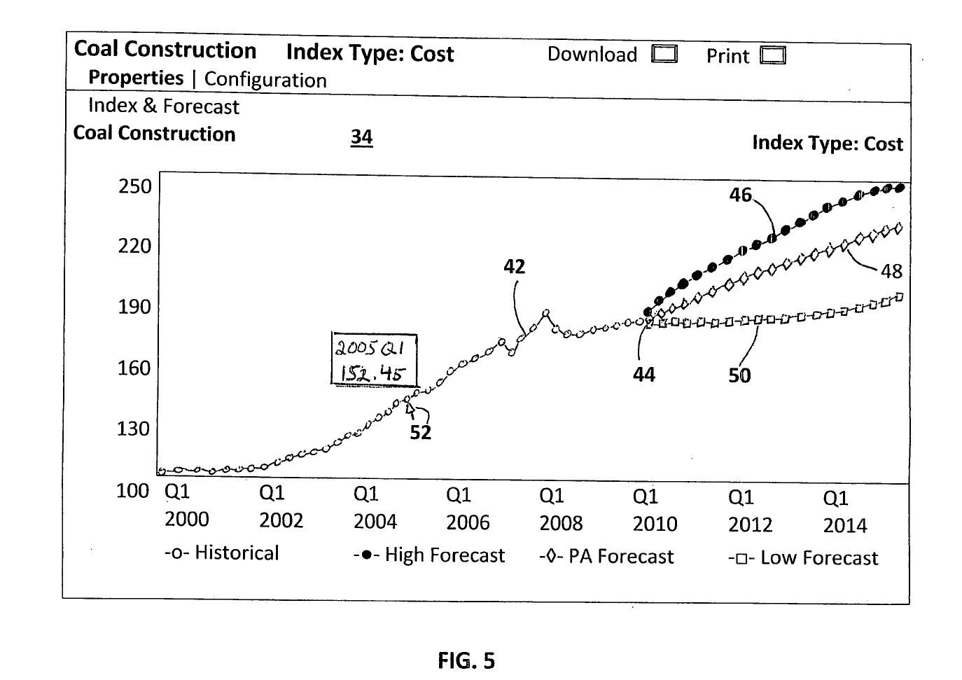

FIGS. 5-7 show expanded views of panels 34, 36, and 38, respectively. Index & Forecast panel 34 shows a graph of the normalized values of the Coal Construction model. Historical index values 42 extend from 2000Q1 to 2010Q4 (44) in the illustrated embodiment. There are three sets of forecast index values: high forecast 46, middle forecast 48, and low forecast 50. Pointing a cursor 52 at one of the data points of the graph reveals the index value and quarter-year period for that point, as illustrated for the data point for 2005Q2, which has an index value 145.545.

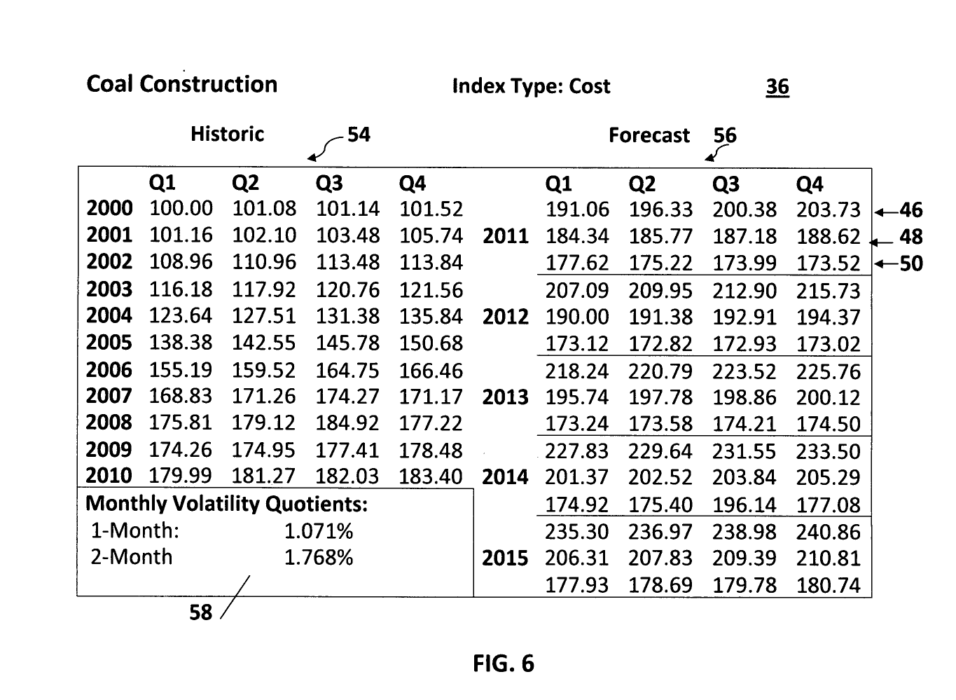

Data panel 36 is expanded in FIG. 6 and shows a list of the quarterly historic index values 54, and a list of the quarterly forecast index values 56. The forecast values 56 for each of the high forecast 46, the middle forecast 48, and the low forecast 50. Also shown in panel 36 are the monthly volatility quotients 58 for the present term (2010Q4).

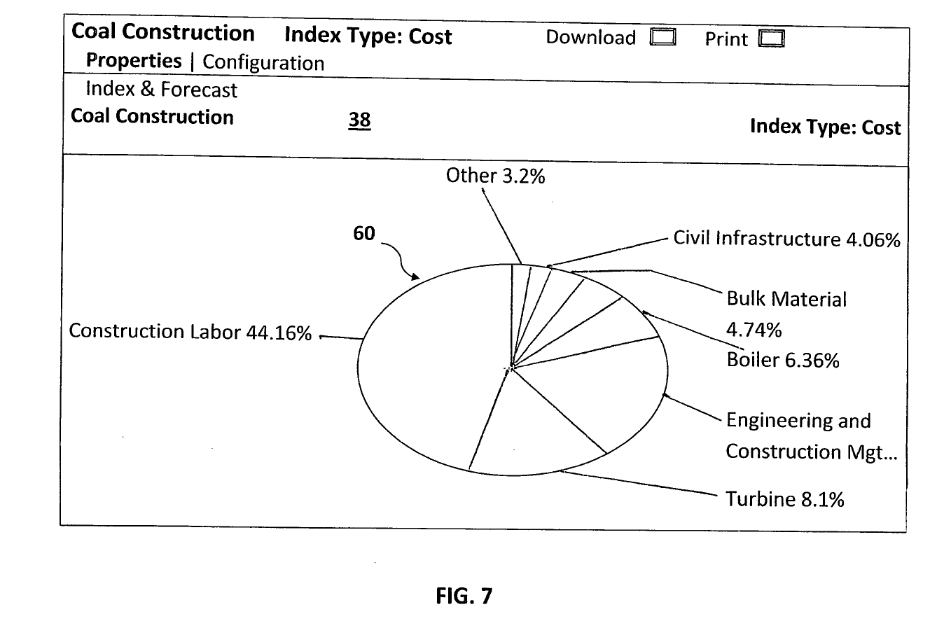

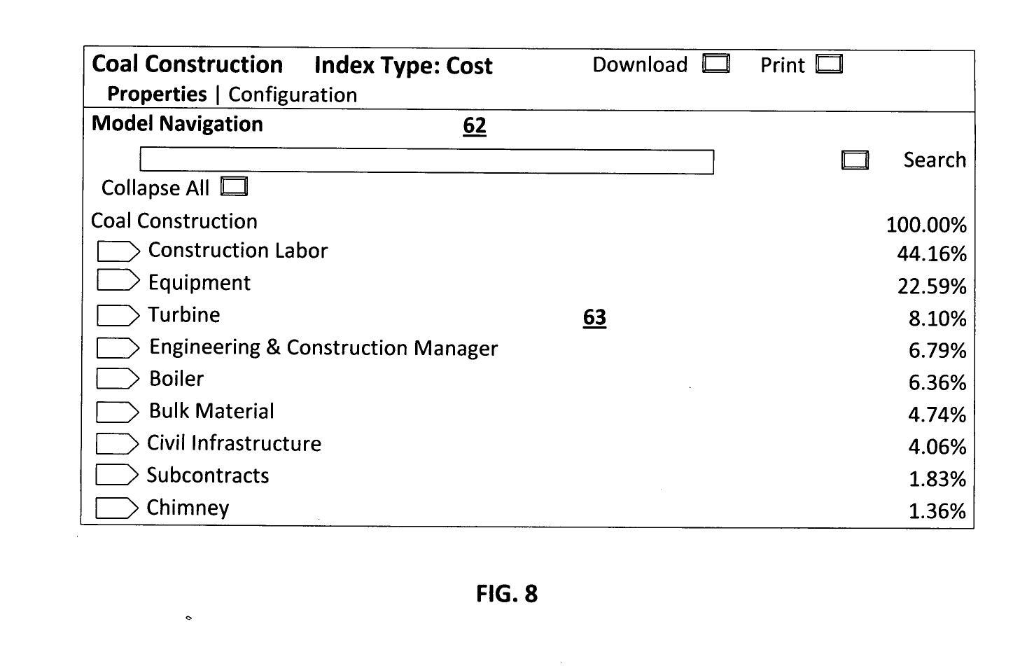

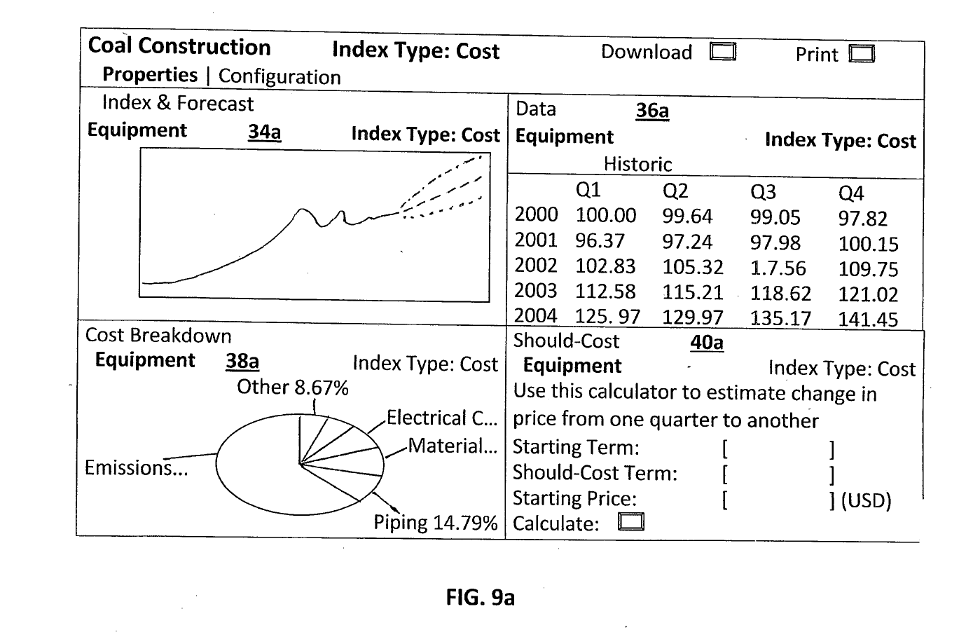

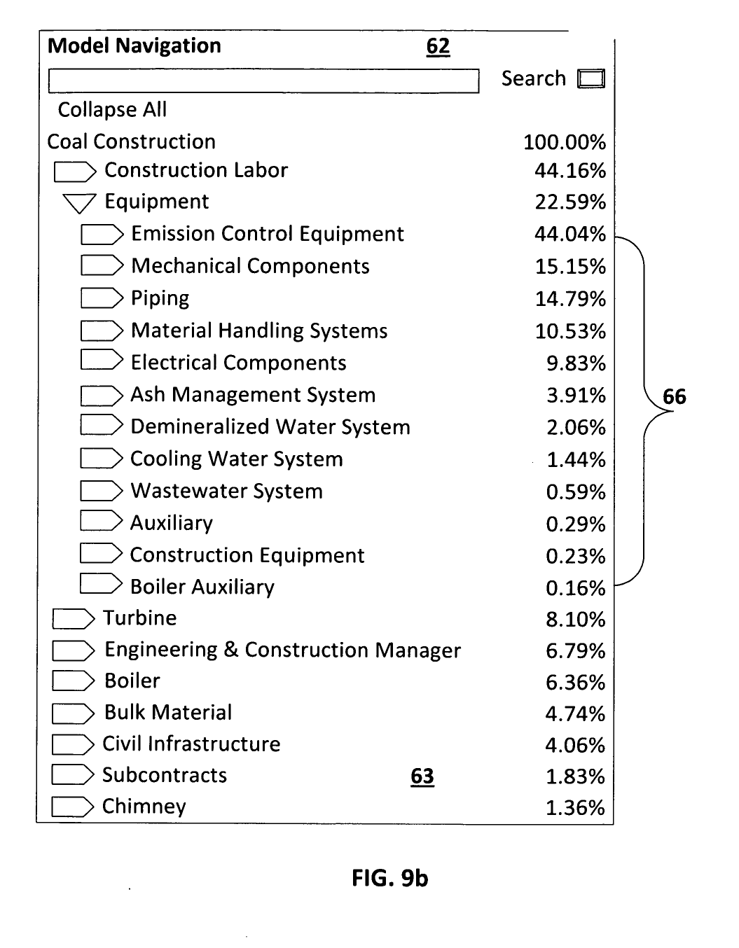

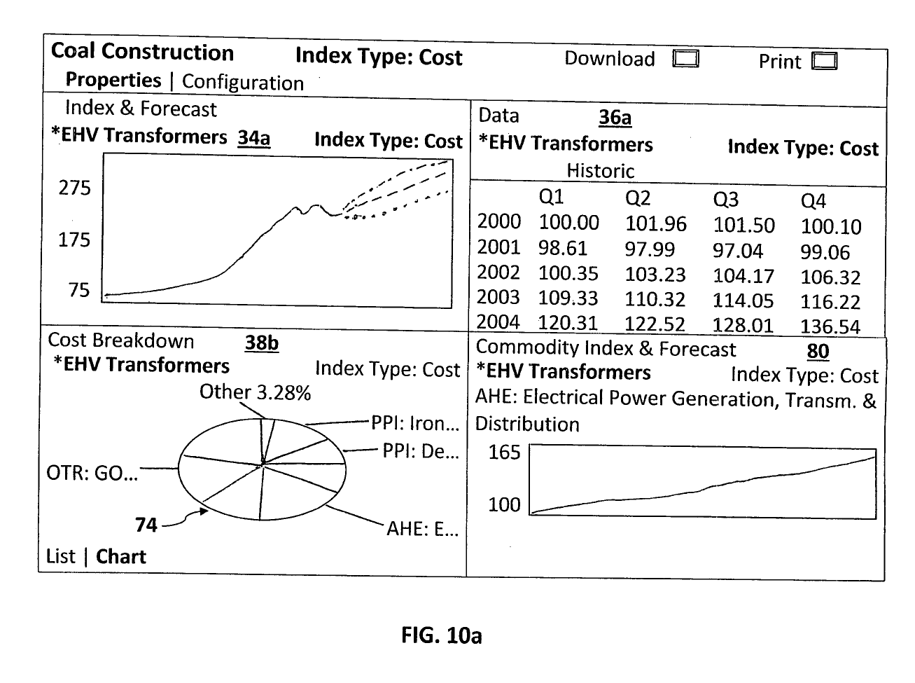

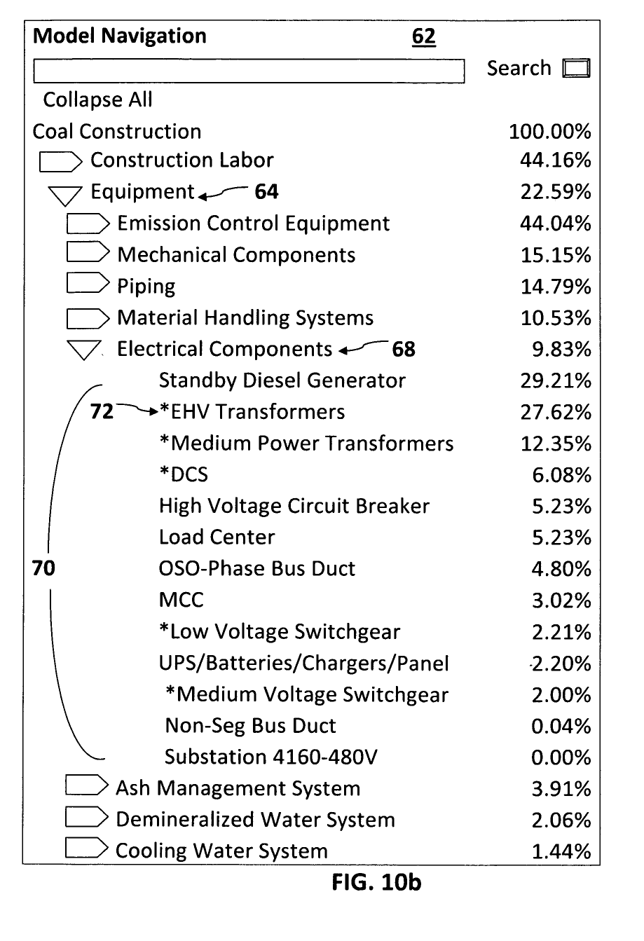

Cost breakdown panel 38, shown in FIG. 7, is a perspective pie-chart graphical representation 60 of the percentage contributions of each category of the coal construction model for the present term. Model Navigation panel 62, shown as a bar on the right side of FIGS. 4, 5 and 7, can be selected and expanded as illustrated in FIG. 8. It provides a listing 63 of the constituent categories of the model and the percentage contribution of each. A category in the list can be expanded to show a listing of its constituent sub-categories by selecting the button to the left of the category, as illustrated in FIG. 9 wherein the Equipment category 64 has been expanded to show its sub-categories 66. The expanded category 64 can be collapsed by again selecting the button to its left. A user can also navigate to the index and commentary information for a selected category by placing the cursor 52 on the name of the selected category in the list and selecting it. FIG. 9 shows index information for the Equipment category 64 in panels 34a, 36a, 38a and 40a in manner similar to which respective panels 34, 36, 38 and 40 showed index information for the entire model. A user can navigate through lower tiers of the model in a similar fashion. FIG. 10 illustrates the model dashboard when the Electrical Components sub-category 68 is selected and expanded. Model navigation panel 62 now shows a list of the constituent items 70 in the Electrical Components sub-category 68 of the Equipment Category 64 of the exemplary Coal Construction model. The asterisks next to some of the items indicate that those items include a description and other information in the commentary panel (not shown).

The EHV Transformers item 72 has been selected from the item list 70 so that panels 34b, 36b, and 38b show index information for that item in a manner similar to which panels 34, 36, and 38 showed information for the model, and panels 34a, 36a, and 38a showed index information for a category. The commentary panel and the Should-Cost panel for item 72 are not shown on the dashboard illustrated in FIG. 10, but the user can scroll down to view these panels.

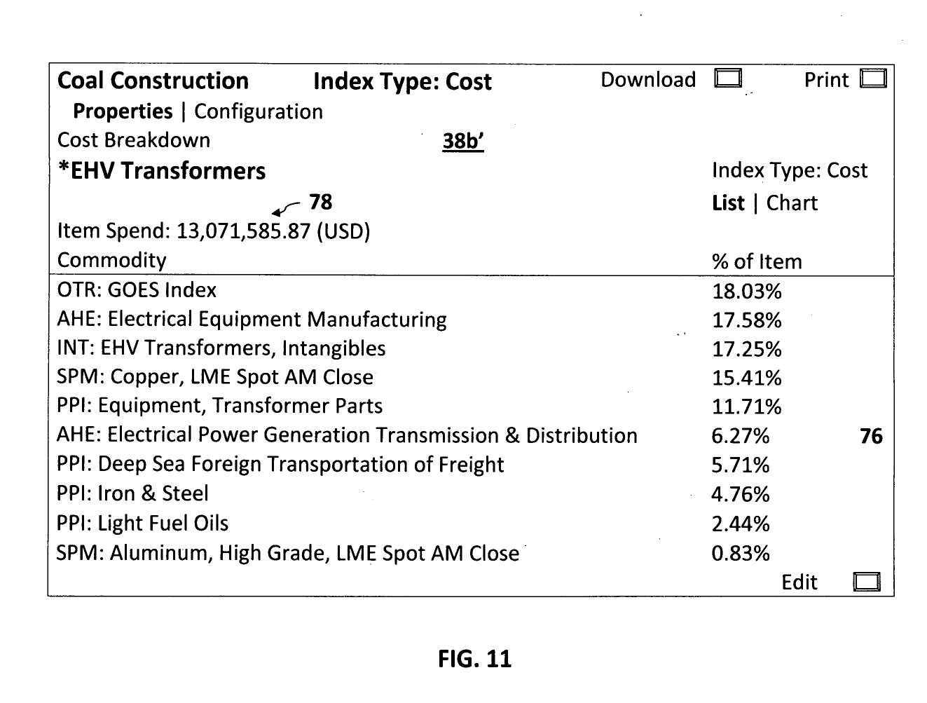

The Cost Breakdown panel 38b has a feature that allows a user to switch between a chart view of a pie chart 74 showing the percentage contribution of each commodity cost index that is included in the item being displayed, and a list view. A list of the constituent commodity cost indices 76 is shown in FIG. 11 in Cost Breakdown panel 38b′. An index value of a cost for the item 72 in the present term is shown at 78.

Commodity Index & Forecast panel 80 permits a user to explore a graphical view of each of the commodity cost indices for the selected item 72. An expanded view of panel 80 is shown in FIG. 11, which illustrates the commodity index PPI (producer price index): Iron & Steel for historical values 82 and high, middle, and low range projected future values 84. The name of the displayed commodity index is shown in panel 86. By selecting the button 88 the user can open a dialog box (not shown) with a list of all the commodity cost indices included in the item. Selecting one of the listed commodity cost indices will then change the display in panel 80 to show a graph of the selected commodity index and its name in panel 86.

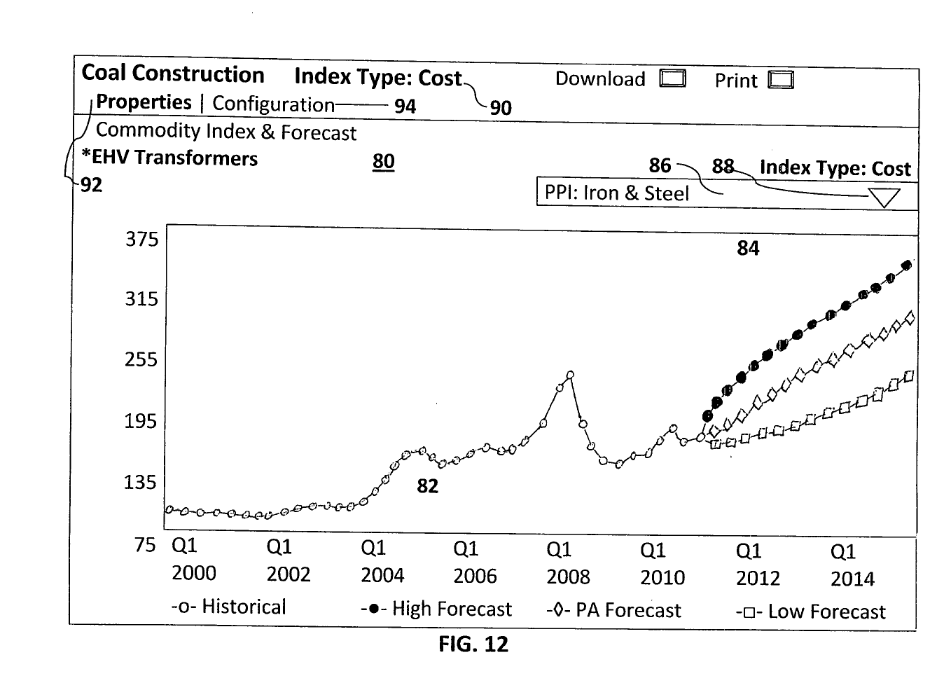

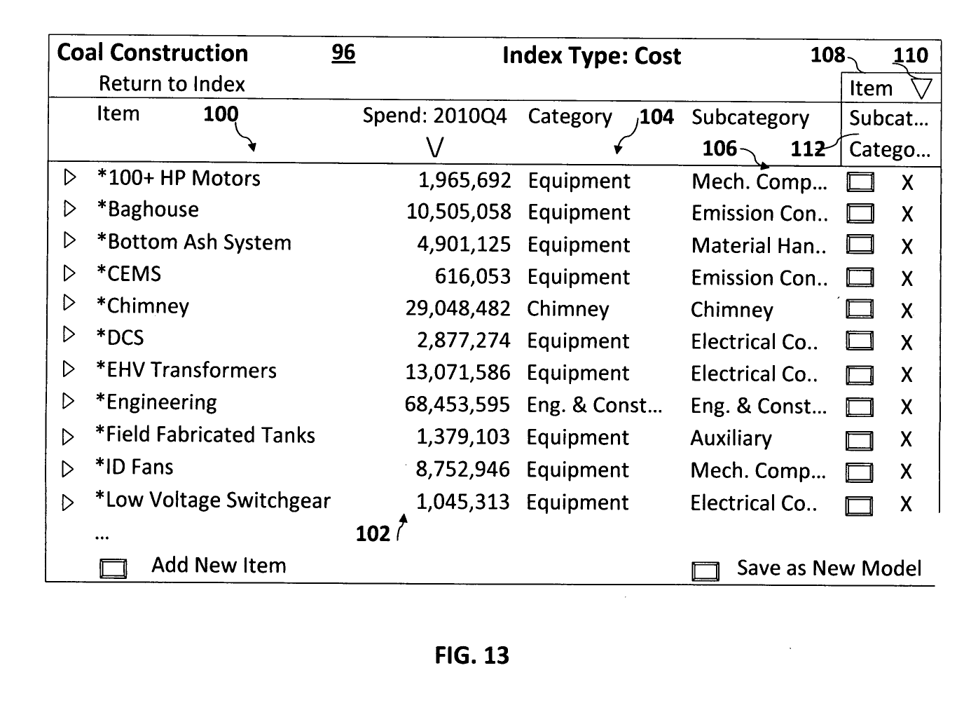

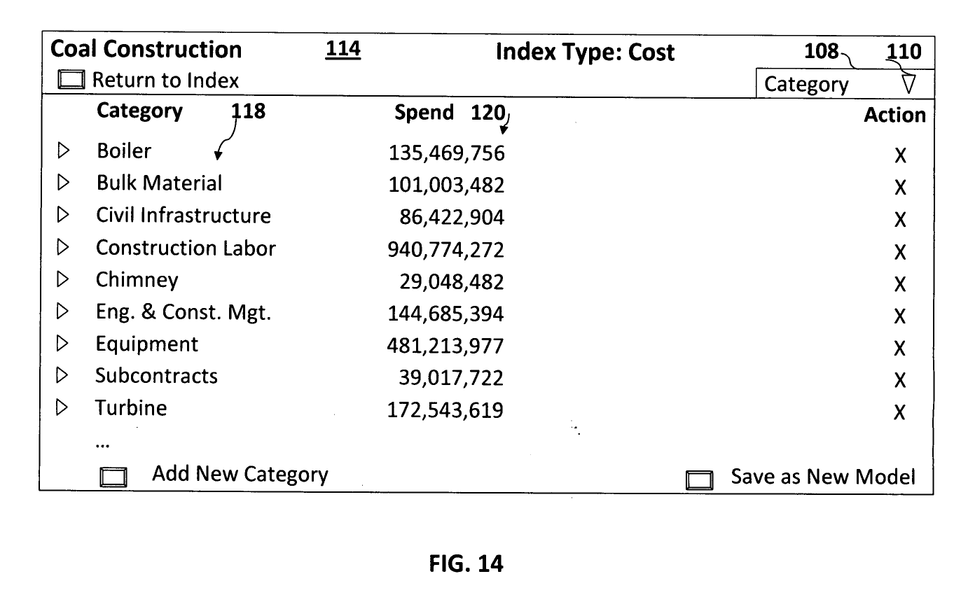

Near the top left of each of the dashboards described above with reference to FIGS. 4-12, and just below the model name 90, are the Properties view 92 and Configuration view 94 options. Placing the cursor 52 over Configuration view 94 and selecting brings up the configuration dashboard 96 shown in FIG. 13. Item configuration table 98 includes all the items in the model listed in the item column 100 and each respective item spend for the present term (2010Q4 in the described embodiment) in the item spend column 102. Items not shown on a user's display can be viewed by scrolling down. The category and subcategory to which each respective item belongs is shown in the category column 104 and the subcategory column 106. At the top right of configuration dashboard 96 is a configuration selection panel 108. Selecting the panel button 110 opens a configuration selection dialog box 112, which allows a user to select from the item configuration table 100, or from category or subcategory configuration tables, 114, 116, as shown in FIGS. 14 and 15 respectively. Category configuration table 114 includes a category column 118 listing all the categories in the model, and a category spend column 120 indicating each category's spend value for the present term. Subcategory configuration table 116 has a subcategory column 122 listing all the subcategories in the model, a subcategory spend columns 124 showing each subcategory's respective spend values for the present term, and a category column 126 that shows the category to which each subcategory belongs.

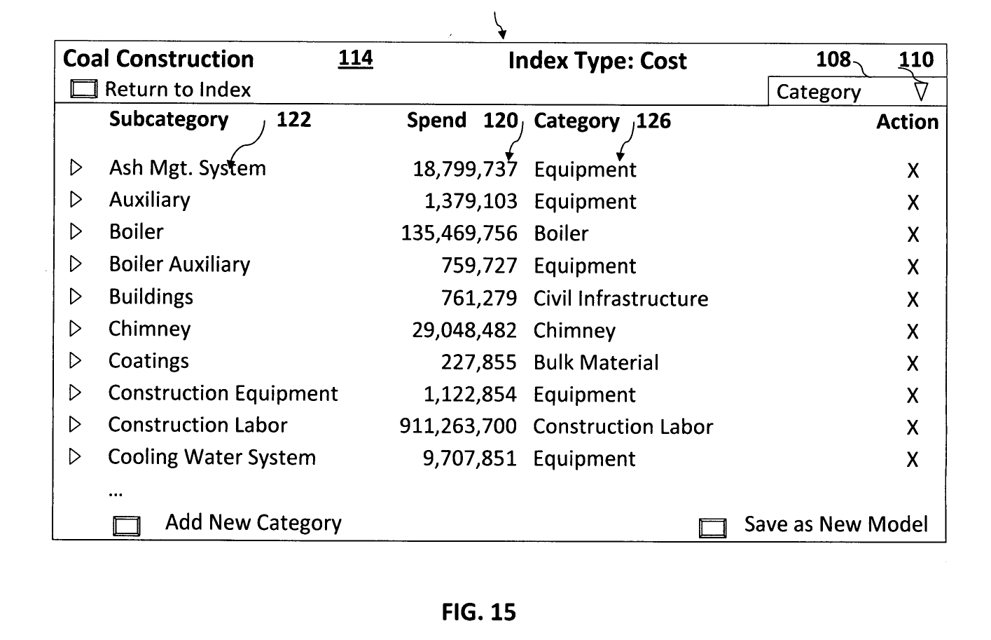

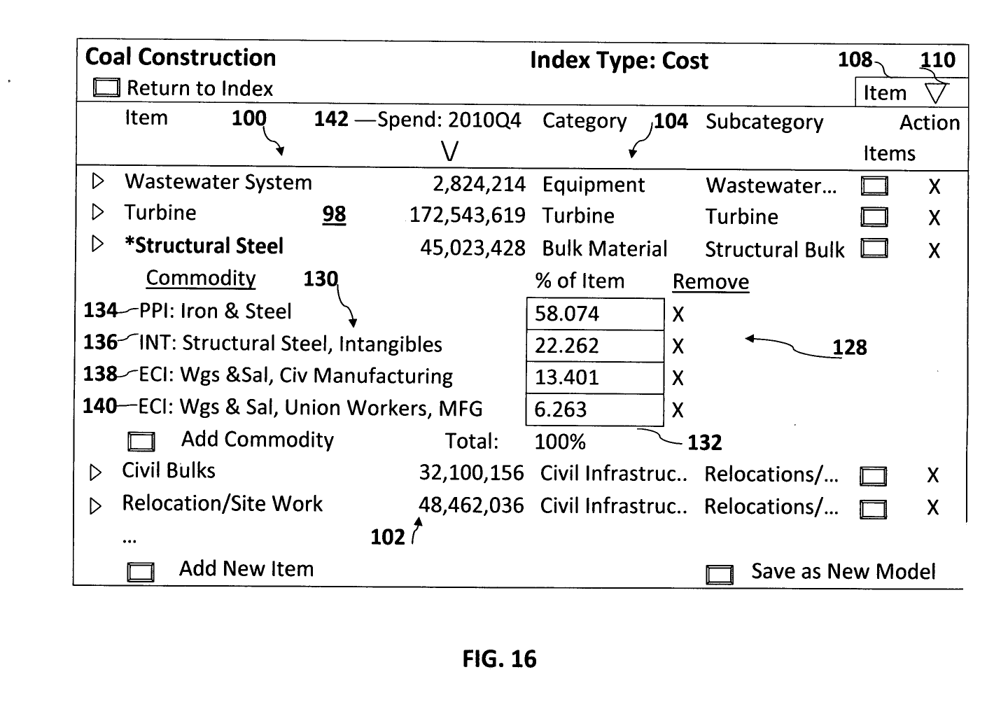

FIG. 16 shows the item configuration table 98 wherein the button to the left of the Structural Steel item has been selected to reveal that item's commodity table 128. Commodity table 128 has a commodity column 130 that lists all the commodities, and a commodity percentage (%) of item column 132 that indicates the percentage contribution to the item spend of each commodity for the present term. This item has four commodity indices, including a producer price index for iron and steel (PPI 134), an intangibles index (INT 136), a manufacturing wage and salary cost index (ECI 138), and a manufacturing wage and salary cost index for union workers (ECIU 140).

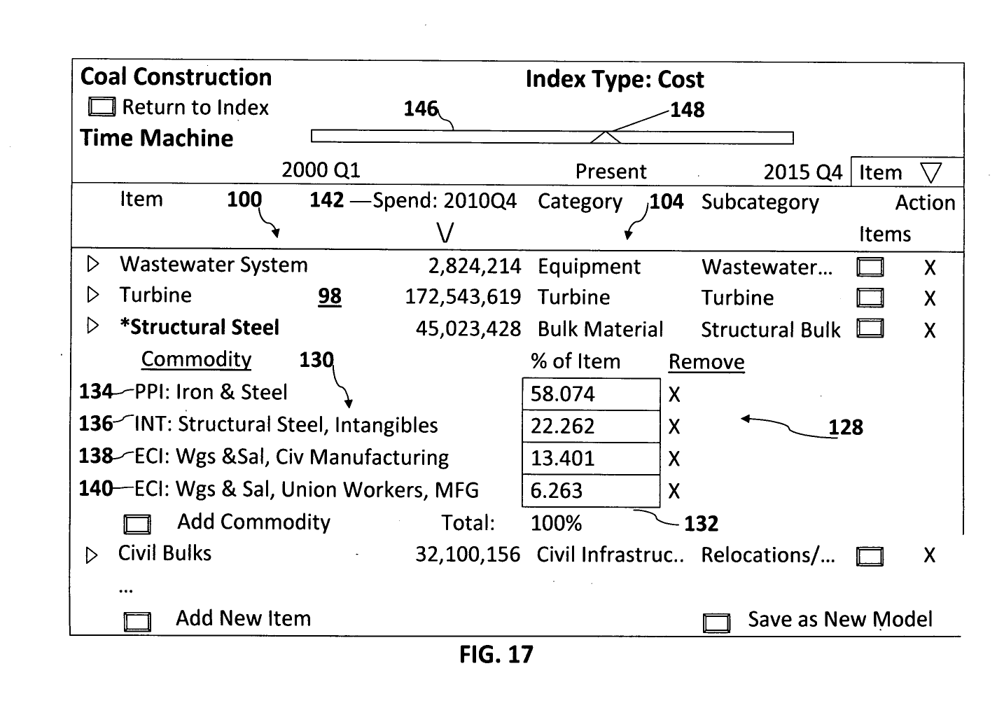

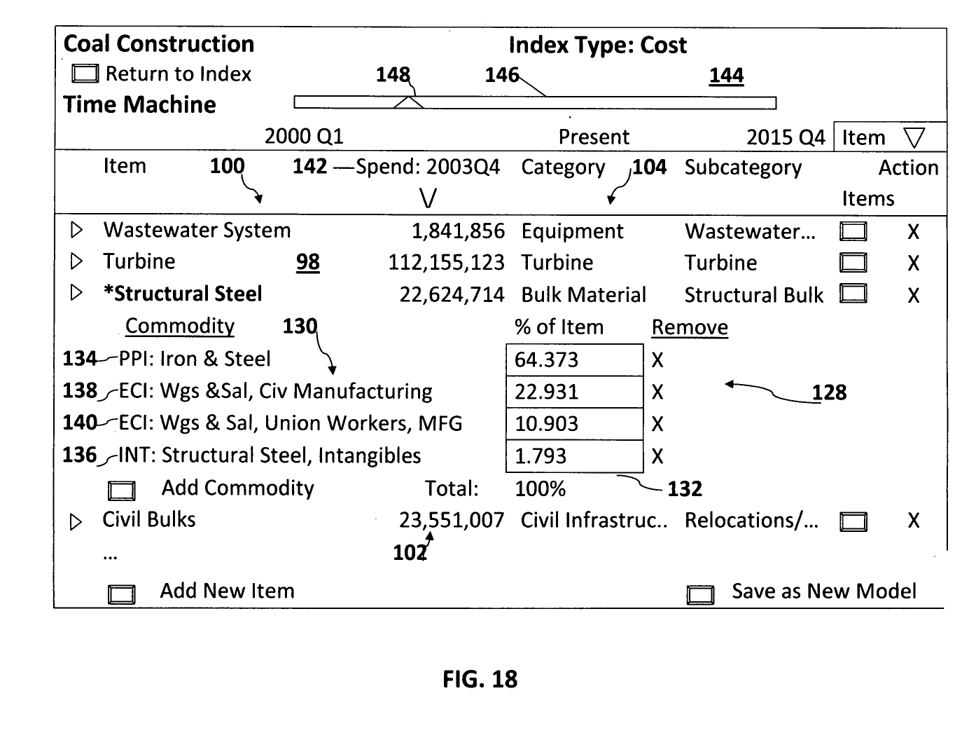

A legend 142 located above the item spend column 102 indicates the quarter-year term for spend amounts shown in table 98. As mentioned above, the default time period is the present term. Referring now also to FIGS. 17-18, when a user selects on the item spend term legend 142, for example, by clicking on it with a mouse, it opens an application for making custom calculations and revising the model, called the Time Machine (TM) on the described embodiment's TM dashboard 144. A sliding time scale 146 appears above the item table 98. When a user moves a TM button 148 on the sliding scale 146 to a new position, e.g. by moving it with the cursor, it changes the cost values displayed on the item table 98 to the cost values for the quarter-year time period, or term, corresponding to the position of the TM button 148 on the time scale 146. FIG. 18 shows item table 98, wherein the TM button position selected by the user corresponds to the fourth quarter of 2003. The selected time period, 2003Q4, has replaced the present term (2010Q4) in item spend term legend 142 to indicate that the spend figures being shown correspond to the selected term. In this example, the Structural Steel item spend has changed from $45,023.428.00 to $22,624,714. The figures for the other items shown in FIGS. 17-18 are also changed by varying amounts. Commodity table 128 has also been refreshed with commodity index values corresponding to the selected time period. Each commodity's % of item value in column 132 is changed from what was displayed for the present term.

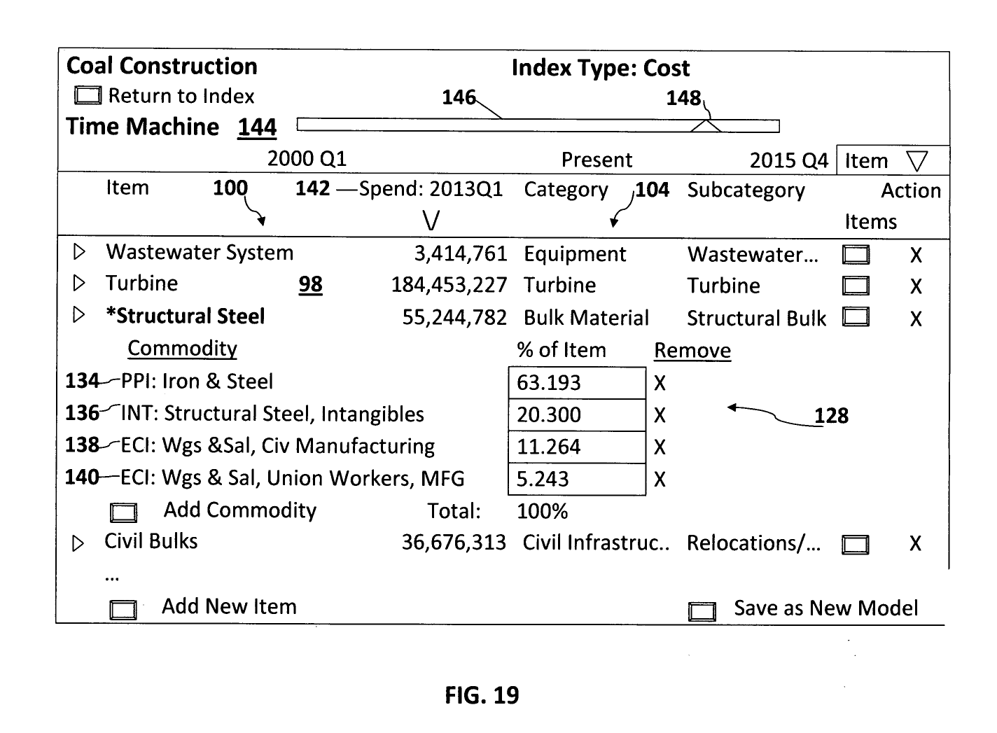

A user can also select a time period in the future to access the forecast index values. This is shown in FIG. 19, wherein the selected term is 2013Q4. As can be seen by comparing the figures for the structural steel item spend index values, the cost of that material is predicted to significantly increase in the three year period between the present term and the selected term. Comparing the percentage contributions of its constituent commodities between the two terms indicates that the increase is mainly attributable to an expected increase in the PPI for iron and steel.

The Time Machine application can only be accessed through the index configuration dashboard. In the embodiment described with reference to FIGS. 17-19, the application was opened after expanding a selected item to show its commodity table 128. The Time Machine application can also be opened with more than one item expanded, or with no items expanded in this manner.

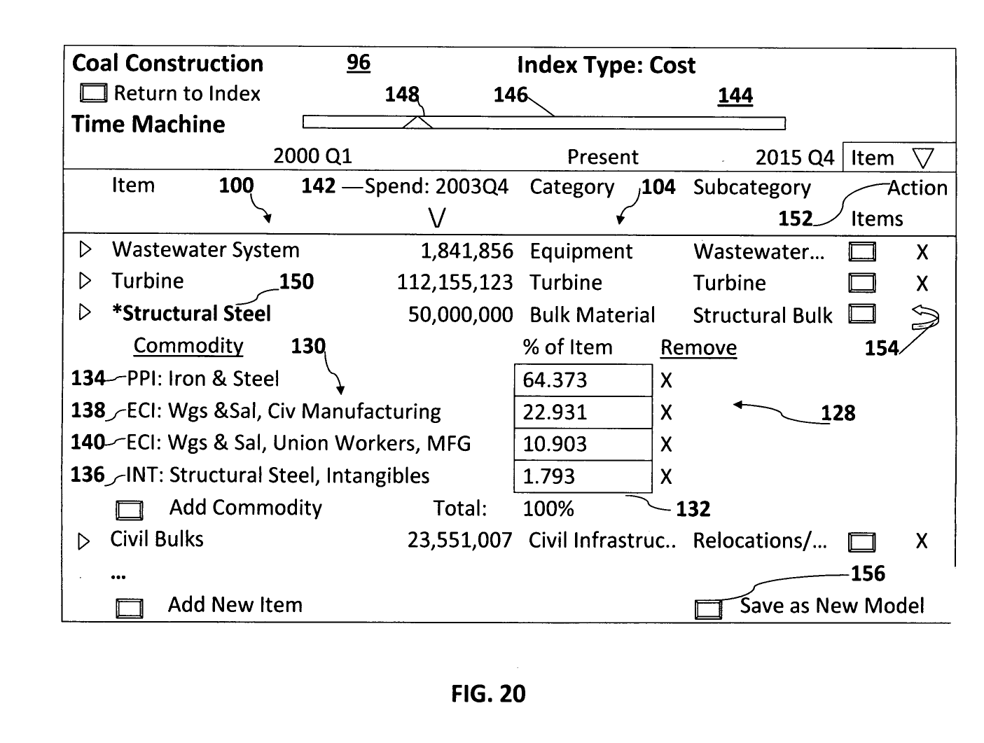

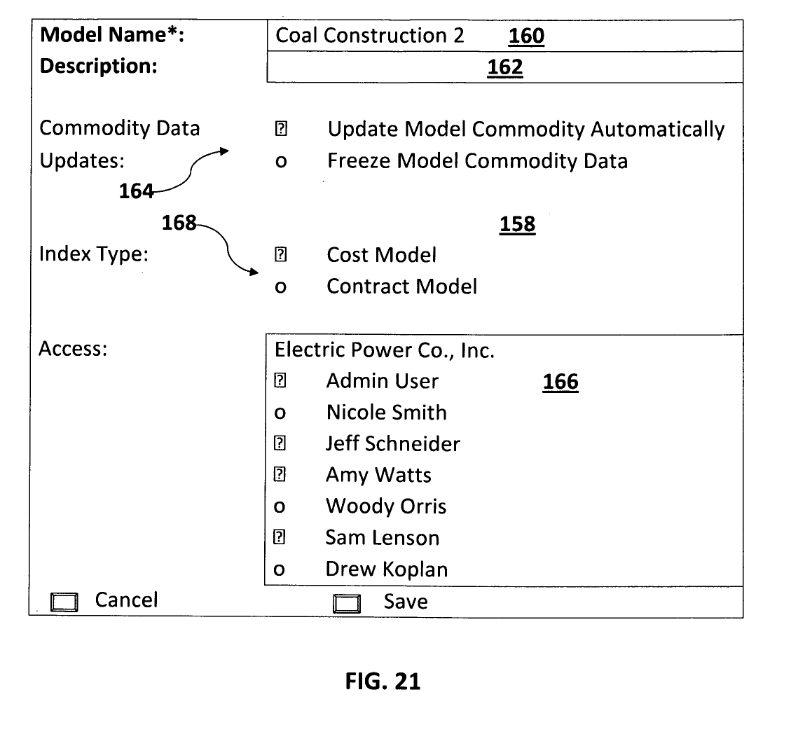

The Time Machine application can be used to view item cost index values and their constituent commodity percentage contributions at both historical and future time periods, as described above. The Time Machine application also provides a simple to use tool to modify a model. One manner of changing a model is by replacing an item spend amount for a selected item at a selected time period within the range of the model, and then saving the change either in the same model or as a new model. Referring now to FIG. 20, the Structural Steel item cost index is illustrated as in FIG. 17 for 203Q4, however the item spend amount for this selected item 150 has been changed from $22,624,714 to $50,000,000. In the Action column 152 the icon X for that line has been automatically converted to a reverse arrow icon 154. Selecting the reverse arrow 154 will reverse the change just made to the spend amount for the selected item 150. The user can save the change by selecting the Save As New Model button 156. When button 156 is selected a new model information dialog box 158 appears on the display, as shown in FIG. 21. In order to save the new model, the application requires the user to enter a name for the new model at Model Name box 160. The user may optionally enter a description of the model at description box 162, and select at commodity data updates buttons 164 whether to update the model commodity data automatically, or freeze the model commodity data, as will be explained in more detail. A check-box permission list 166 of other users within the enterprise is presented to allow the user who created the new model to grant them permissions them to access the new model, if the creator of the new model wishes to do so. The user also has the option to save the new model as a cost model or as a contract model by choosing the corresponding option at index type buttons 168. If saved as a contract model, the indices will be recalculated as if the selected time period for which the change was made was the initial date of a contract (or the ‘contract term’), and the normalized values for all indices in the model will be set to a value of 100 for the contract term so that percentage changes at subsequent terms will be readily apparent. In this example, the new model is saved as a cost model with the name Coal Construction 2, and with the model commodity data being updated automatically.

When saved, the new model is the displayed model. It is also added to the list of My Models 28a for the user who created it, and to the list of My Company's Models 28c for other users who have been granted access by the model's creator.

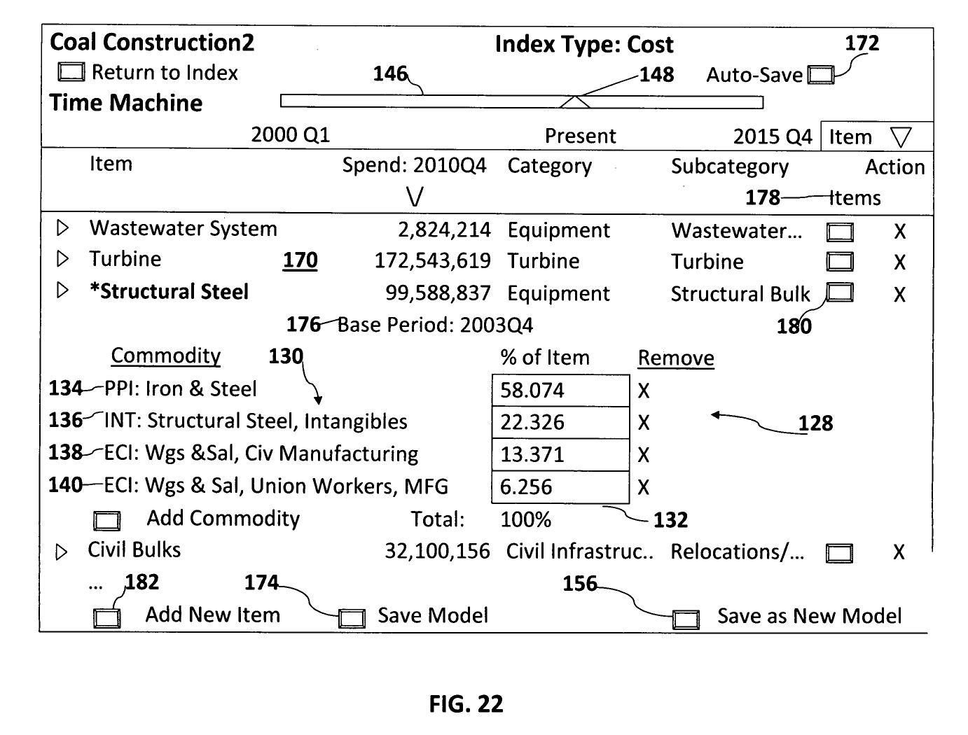

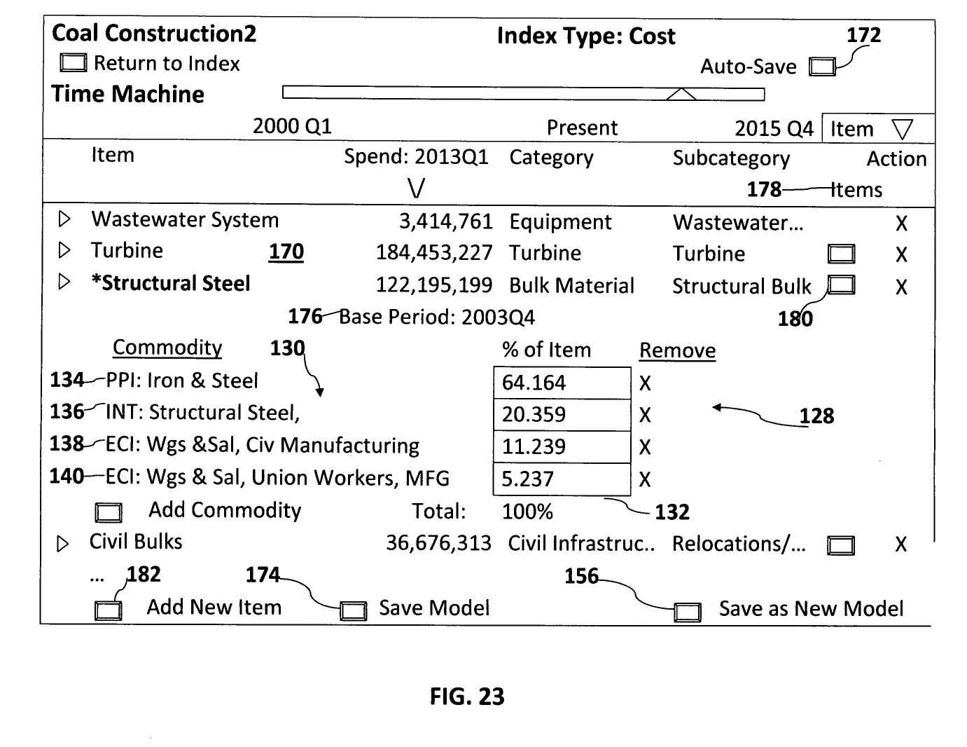

FIGS. 22 and 23 illustrate the item configuration table 170 of the saved new model, with the Time Machine application set for the present term (2010Q4) and a future term (2013Q4), respectively. There is a new auto-save check-box 172 on these screens that when checked will cause the application to automatically save additional changes the user makes to the model. Before the user could only save a change as a new model. Now, the user can now save additional changes either as a new model by selecting on button 156, or save additional changes within the same model by selecting on Save Model button 174. These features are only allowed for models that are in the user's list of My Models 28a.

The Base Period column 176, which had no entries previously, now indicates that the selected item 150 was reset at for 2003Q4. Next to the Base Period column 176 is the item pool column 178. If a user checks the Item Pool box for an item that has been changed, e.g. box 180 for selected item 150, saving will save the changed item cost index in an item pool that includes all the items from all the models that a user can access. This feature allows a user to add the changed item to other models using the Add New Item button 182.

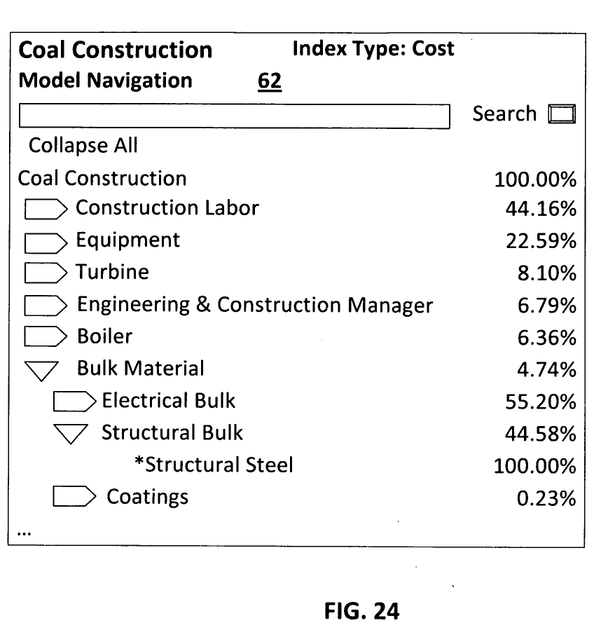

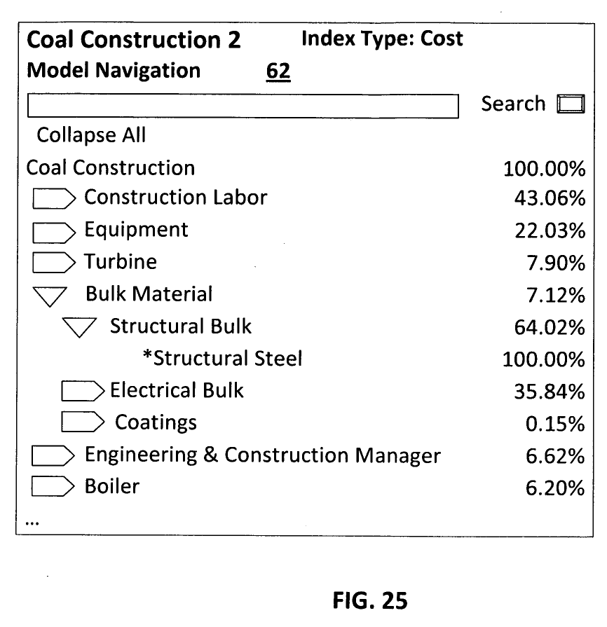

The Time Machine application now displays a recalculated spend amount for each term selected with slide button 148. The cost of Structural Steel has been changed from $45,023,428 to $99,588,837 for the present term, and to $122,195,199 for 2013Q4. The software application also will show revised spend amounts for the Structural Bulk subcategory and for the Bulk Material category because the selected item that was changed for the new model, Structural Steel, is included in those objects. In addition, as can be seen by comparison of the percentages in the model navigation panes 62 of FIGS. 24 and 25 which respectively correspond to the original model and the new model, each constituent item's percentage contribution to the Structural Bulk subcategory will be changed. Also changed will be each subcategory's percentage contribution to the Bulk materials category, and each category's contribution to the model.

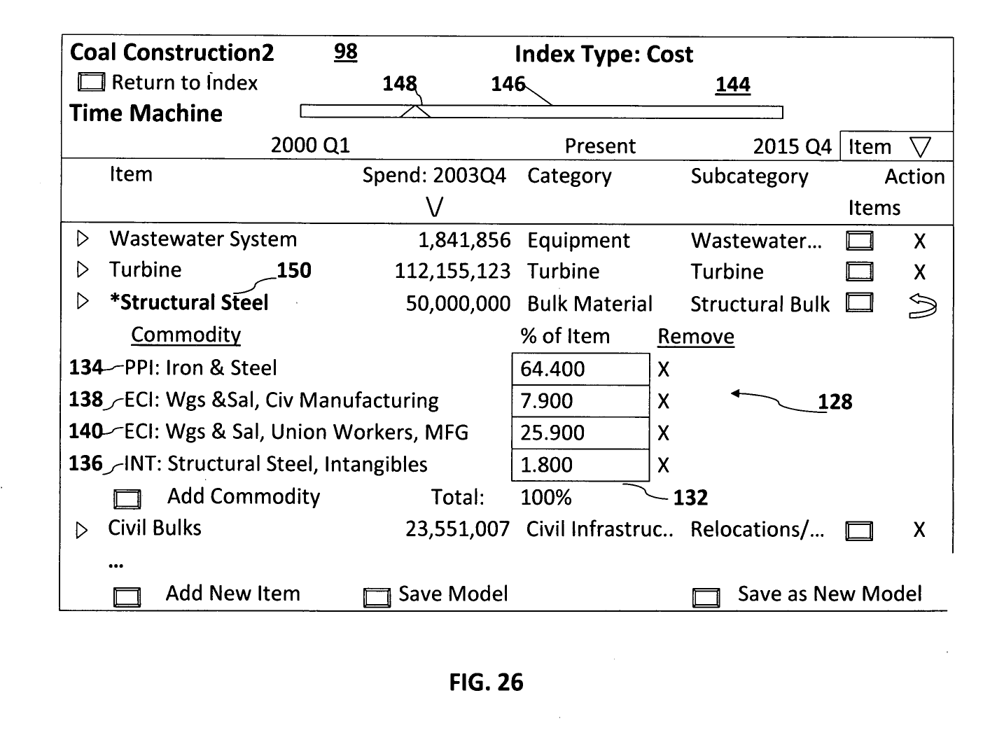

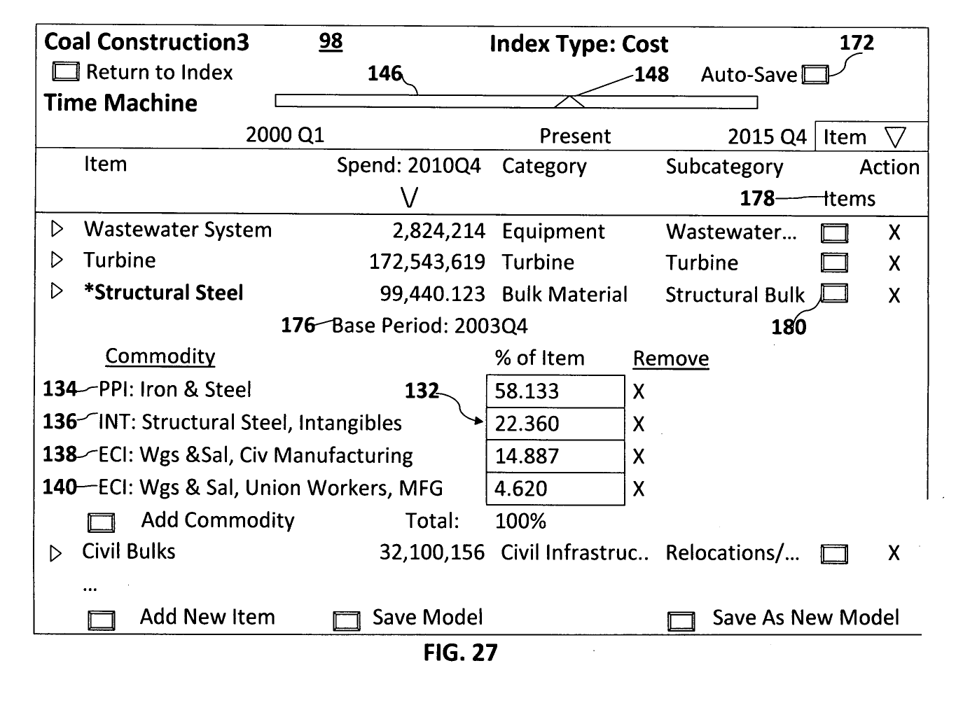

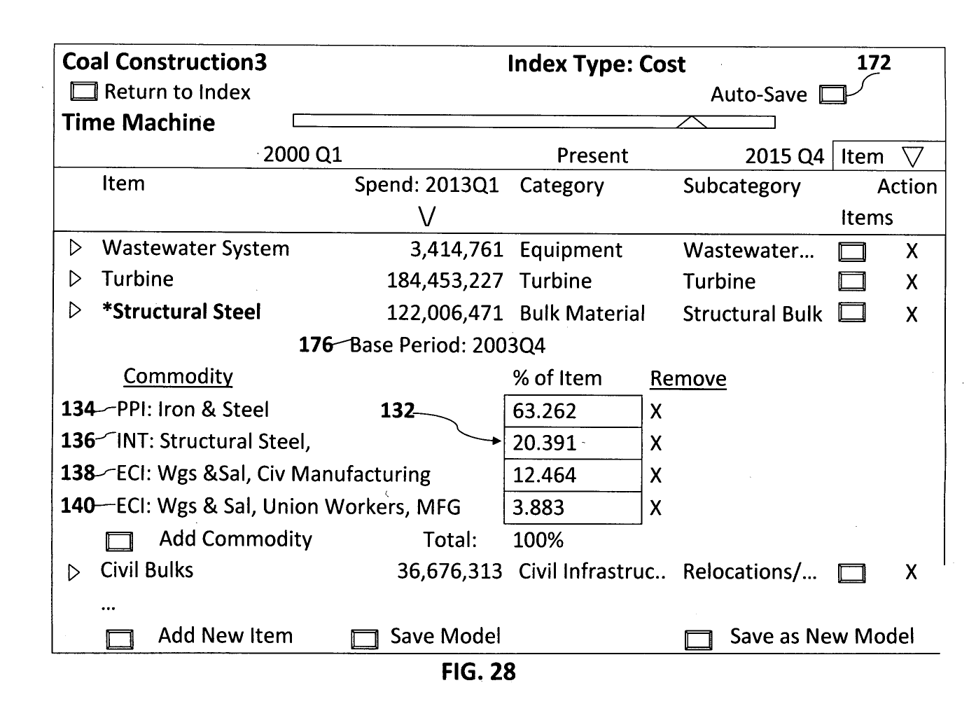

Another method of changing a model using the Time machine application is by changing the percentages of an item's constituent commodity indices for a selected time period within the range of the model. FIG. 26 shows the TM dashboard 144 with Structural Steel being the selected item 150, and with 2003Q4 being the selected term. The commodity figures in the % of item column 132 have been changed from those shown in FIG. 19 in that ECI 138 has been reduced by 15% and ECI U140 has been increased by 15%. In this example, the new figures are saved in a new model named Coal Construction 3. FIGS. 27 and 28 show item configuration table 98 views of the new model similar to those in FIGS. 22 and 23, respectively, for the present term and for 2013Q4.

As previously described, a cost model includes cost information over a range of time that includes an historical period and a future period. Data in the model is associated with discrete segments of time, or terms Ti, within that period of time. In the described embodiment the time range of the model is fifteen years, and there are sixty sequential quarter-year terms, i.e. T1≦Ti≦T60. The historical period ranges from T1 to Tp, where Tp is the most recent historical term, called the present term. The future period of the model extends from Tp+1 to T60. A facility model (MOD) is stored in memory 14 as a hierarchal table of categories (CAT), subcategories (SCT), items (ITM), and commodities (COM). Each item in the model within a subcategory is unique, even if there is another item having the same name in a different subcategory within the model. Similarly, each subcategory is unique, and each category in the model is unique, regardless of how it is named.

Each item has associated with it set of commodities. For each commodity, the model stores a reference spend value COM(Vref) for a reference term, which is typically the first term T1, and a normalized commodity index value COM(ITi) for each term, which is set to a value of 100 for T1. The spend value for an item at any term, ITM(VTx), is equal to the sum of the spend values for each of its constituent commodities, or

$$ITM ( VTx ) = {\sum }_{i = 1}^{n} COMi ( VTx ) ,$$

where

$$COMi ( VTx ) = ITM ( VTref ) * \frac{COMi ( ITx )}{COMi ( ITref )} .$$

The commodity percentage contribution COM(PTx) to the item spend for term TX is given by

$$COMi ( PTx ) = \frac{ITM ( VTx ) * 100}{COMi ( VTx )} .$$

Similarly, the subcategory spend values are the sum of the constituent item spend values for any term, the category spend values are the sum of the constituent subcategory spend values, and the facility model spend value is the sum of the category spend values for any given term Tx, and the calculation of percentage contributions of sub-objects within any object is straightforward.

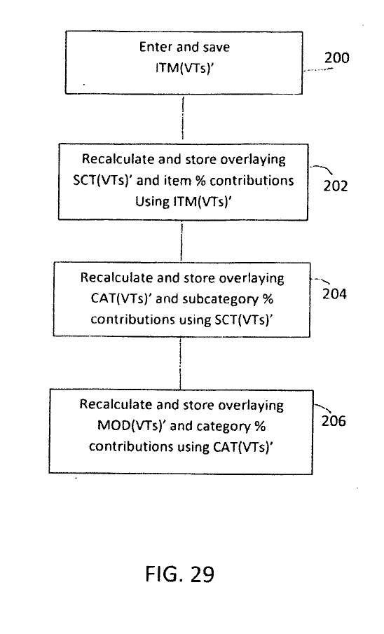

Referring now to FIG. 29, when a user enters a new item spend value for a selected term, ITM(VTs)′(step 200), the Time Machine application software instructs the processor 16 to recalculate the model as follows. First, the application uses the new item spend value ITM(VTs)′ to recalculate the overlaying subcategory spend value SCT(VTs)′ and the item percentage contributions for Ts (202), and store those values in memory 14. Next it recalculates the overlaying category spend value CAT(VTs)′ and subcategory percentages (204) for Ts using SCT(VTs)′, and then it recalculates the facility model spend value MOD(VTs)′ and category percentages using the recalculated CAT(VTs)′ (206), saving the results as it does so.

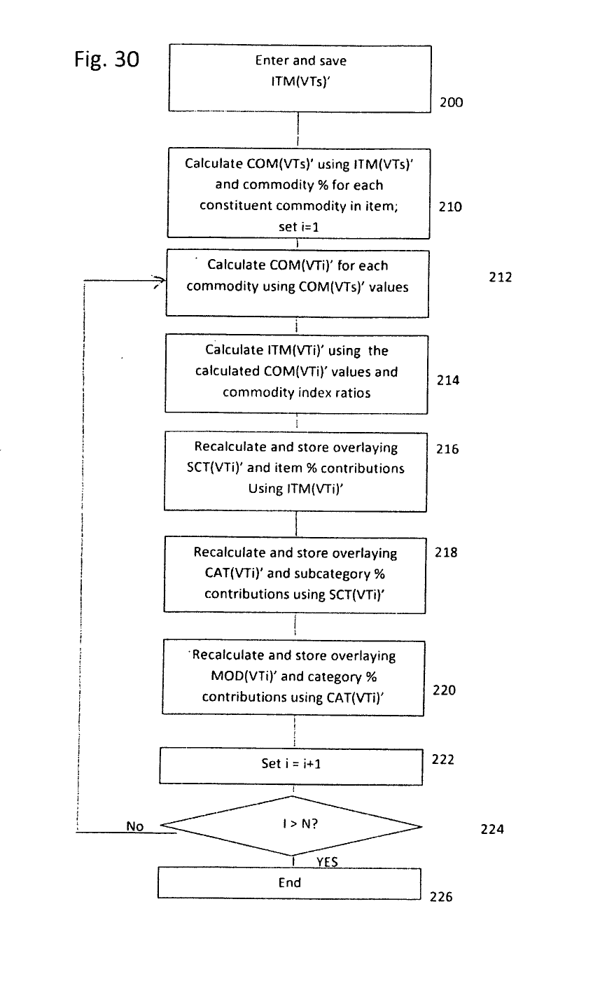

The processor also recalculates the item's commodity spend values for Ts, COM(VTs)′, and uses these spend values to recalculate the item spend values for other terms throughout the model. Referring now to FIG. 30, when a user enters and saves a modified item spend value for a selected term ITM(VTs)′ (step 200), the application software, at step 210, causes the processor 16 to calculate and save each COMi(VTs)′ according to the formula COMt(VTs)′=ITM(VTs)′*COMt(PTs), and sets an index value n=1. At step 212, the processor then calculates the commodity spend value for each commodity for the first term T1 using the recalculated commodity spend value for Ts and the ratio of the commodity index values according to the formula COMt(VT1)′=COMi(VTs)′*COMt(IT1)/COMi(ITs), saving the result and repeating for all commodities. Once all the commodity spend values are calculated for T1, their sum provides the item spend value ITM(VT1)′ for T1 (step 214). This result is used at step 216 to recalculate the overlaying subcategory spend value SCT(VT1)′ and the item percentage contributions for Ti. The result is stored and used to calculate at step 218 to recalculate the overlaying category spend value CAT(VT1)′ and subcategory percentages for T1 using SCT(VT1)′. This result is then used at step 220 to recalculate and store the facility model spend value MOD(VT1)′ and category percentages using the recalculated CAT(VT1)′. The index value n is changed to n+1 at step 222. If n is not greater than the number of terms (224), process starts repeating at step 212 for the next index value to calculate model values for the term Tn+1, otherwise the process ends (226). If the model includes more than one projected future index, as in the exemplary model, it is a simple matter to extend the calculations to each future index. When the calculations are complete the newly saved model can be accessed, displayed and modified by the user.

If a user changes and saves a model with a change to the percentage contributions of commodities to an index at a selected time, the calculations are done in a similar manner, but the commodity percentages used in step 210 will be the percentages entered in by the user instead of the original percentages that were in the model for the selected term.

The described embodiment illustrates one possible embodiment of the invention. Other embodiments are within the scope of the appended claims.

What is claimed is:

1. A method of changing a hierarchal cost model of a facility system, wherein the model includes model data representing cost indices of the system and its constituent components over a model time period, the model time period including an historic time period extending from a first time term T1 to a term near the present Tp and over a future time period extending from a term Tp to a final term Tf, the model data including a plurality of levels that each include one or more indices, the highest level being a facility level that includes a facility index representing a facility cost of the facility system at discrete terms Ti during the historic and future time periods, the model further including an item level that includes item indices each representing an item cost of a constituent item at each Ti, the item indices being based in part on transaction information data, and wherein each item index is comprised of one or more commodity indices that each represent a commodity cost of a constituent commodity of that item at each Ti, the model data being stored in an electronic data storage device that can be accessed with a computer system that includes a user display, a user input device, and a processor programmed to perform commands entered in the computer system by a user, the method comprising the steps of:
displaying a cost value ITM1(VTs) for a first item at a selected Ts;
replacing the ITM1(VTs) on the display with a user selected second cost value ITM(VTs)′;
using the processor to recalculate the item index of the first item at other terms ITM(VTi)′ based on ITM(VTs)′ and the item's constituent commodity indices; and
saving the recalculated model data in a revised model.
